(19) United States
(12) Patent Application Publication
(10) Pub. No.: US 2013/0255453 A1
(43) Pub. Date: Oct. 3, 2013

(54) VACUUM BLOCKING FOR MANUFACTURING OPTICAL DEVICES

(71) Applicants: Jensen Buck, Goleta, CA (US); Anand Doraiswamy, Goleta, CA (US); Carolyn Finney, Goleta, CA (US)

(72) Inventors: Jensen Buck, Goleta, CA (US); Anand Doraiswamy, Goleta, CA (US); Carolyn Finney, Goleta, CA (US)

(21) Appl. No.: 13/437,581

(22) Filed: Apr. 2, 2012

(51) Int. Cl. B25B 11/00; B23B 1/00

(52) U.S. Cl. 82/1.11; 269/21

(57) ABSTRACT

A method of optical lens blank holding on a chuck using vacuum pressure to easily load and unload, and accurately and repeatedly position blanks concentrically with the axis of rotation of the chuck.

### FIELD OF THE INVENTION

This invention relates to a blocking method to be used for the manufacturing, handling, modification, or development of optical devices, particularly ophthalmic devices. More specifically this invention relates to a vacuum-based blocking method for the manufacturing and/or development of ophthalmic devices. A particular preferred application of this invention is to handle, e.g., to produce and to modify, intraocular lenses (IOLs).

The most commonly used methods of blank holding for ophthalmic devices are collect-based systems or wax blocking methods. Radial stress can be induced on a blank that is held in a collect-based system resulting in optical aberrations such as astigmatism and trefoil. Alternatively, using wax to mount blanks requires both blocking and de-blocking steps for each lathe-cut surface. Selection of the wax and method of separation of wax from the ophthalmic device must be taken into consideration, and some materials may not be feasible. Wax also negatively affects the number of cuts and edge quality of processing tools. Both wax blocking and collect-blocking of blanks have the potential drawback of the blank being held askew relative to the rotational axis. Misalignment of the axis of the blank and that of the block causes misalignment of the anterior and posterior optic surfaces, resulting in poor image resolution.

### BACKGROUND OF THE INVENTION

Vacuum-based handling methods for forming, handling, transferring, polishing or treating assemblies and workpieces are disclosed in the following United States patents and patent applications:

U.S. Pat. No. 6,011,630 to Shanbaum et al. “System and Method for Blocking a Lens”;

U.S. Pat. No. 7,637,085 to Newman, System and Method for Transferring Hydrated Lens on an Automated Line”;

U.S. Pat. No. 3,321,201 to Brewster, “Vacuum Chuck Means and Method of Holding Material”;

U.S. Patent Application Publication 2002/0056954 to Schmalz et al., “Device for Fixation of a Workpiece”;

U.S. Pat. No. 2,520,977 to Suben, “Vacuum Lens Block”; and

U.S. Pat. No. 3,134,208 to Richmond, “lens Holding Device”; each of the above patents and patent applications is hereby incorporated by reference herein. The devices disclosed in each of the above patents suffer from one or more drawbacks that are overcome by the present invention.

### BRIEF SUMMARY OF THE INVENTION

Briefly, in one aspect, the present invention is a blocking method of forming an optical device lens blank having two sides into an optical device lens body comprising the steps of:
a. providing and an optical device lens blank;
b. providing a blocking fixture for a lathe cutting apparatus, the fixture having a body which defines a surface configured to cooperate with the lens blank, the body further having a vacuum header and defining a plurality of ports in the surface, the body further defining a series of conduits providing vacuum communication between the ports and the header;
c. applying the lens blank to the surface while generating subatmospheric pressure in the header which, via the conduits and ports, holds the lens blank to the surface on one side; and
d. cutting the remaining side of the blank to at least partially create the lens body surface configuration while holding the lens body to the surface with negative pressure.

In one embodiment a lathe is used to cut the lens body.

In another aspect the blocking method of this invention uses a blocking fixture comprising a vacuum chuck and the vacuum chuck attaches to a machine spindle of a lathe by means including, but not limited to:

a. threads;

b. collets;

c. Morse tapers;

d. Jacob's tapers;

e. adjustable chucks; and

f. set screws.

The vacuum chuck body can be constructed from materials including, but not limited to:

a. stainless steel;

b. brass; and

c. aluminum.

Blocking methods herein include the use of a fixture which is an assembly made up of at least two parts, including the vacuum chuck body and the vacuum chuck face. In this version the vacuum chuck face is discrete and attaches to the vacuum chuck body via methods including, but not limited to:

a. threads;

b. collets;

c. Morse tapers;

d. Jacob's tapers;

e. adjustable chucks; and

f. set screws.

In yet a further aspect a blocking method of this invention includes the use of vacuum chuck face blocking geometry to interface with the optical lens blanks generally to:
a. promote concentricity of the optical lens blank to the vacuum chuck and spindle axes; and
b. eliminate rotation of the optical lens blank relative to the vacuum chuck face.

In another aspect a blocking method according to this invention utilizes a set of two vacuum chucks to cut either convex-convex, convex-concave, concave-concave, or concave-convex optical lenses, the chucks comprising:
a. a first-side vacuum chuck for cutting of the first surface of the optical lens; and
b. a second-side vacuum chuck that interfaces with the first-side-cut of the optical lens so that the second surface of the optical lens may be cut.

Contact lenses and intraocular lenses can be produced using the present invention.

### BRIEF DESCRIPTION OF THE FIGURES

This invention will now be illustrated and exemplified by the attached figures and detailed description which follows. The figures and description are intended to be illustrative and not limiting of the claims which follow.

Thus, there is shown:

FIG. 1 illustrates the first-side vacuum chuck 1 with positioning threads 2, lens blank-positioning fixtures or posts 3, and blank-holding vacuum ports 4 in chuck face 55 located radially away from the axis of rotation. Multiple vacuum ports 4 are symmetrically located throughout the chuck-lens blank interface to increase the force holding the lens-blank and to decrease the chance of rotation of the lens-blank relative to the blocking face or chuck face 55 during lens processing. Chuck face 55 is the surface against which a lens blank 100 (first shown in FIG. 3) will abut and be held by application of a vacuum draw on one side while it is being lathe cut.

FIG. 2 shows a cross-sectional view taken generally along line 2-2 in FIG. 1 where vacuum chamber or header 5 defined by chamber wall or panel 60 connects to blank holding vacuum ports 4 via vacuum conduits 70. It is to be understood that vacuum chuck 1 would be coupled to a. vacuum source such as a vacuum pump (not shown) or a vacuum line (ultimately connected to a vacuum pump, also not shown).

FIG. 3 illustrates in separated or exploded view a material or lens blank 100 after a first-side cut 8 has been made thereto. Vacuum ports 4, when a vacuum is applied thereto, would securely hold lens blank in process 100 against face 55 during, e.g., a lathing step, as well as permitting blank 100 to be transported between process steps.

FIG. 4 illustrates the second-side vacuum chuck 9 the negative geometry of blank first-side cut 8 being shown at radial surface 20. The first-side cut material blank or lens-in-process 100 would be positioned directly against the face 80 of second-side vacuum chuck 9. Vacuum holds blank 100 in place on face 80 when applied.

FIG. 5 shows a cross-sectional view of the vacuum chuck 9 of FIG. 4 and material blank 100 where the interfacing geometry of the second-side vacuum chuck face and first-side cut material blank can be easily seen.

FIG. 6 illustrates the second-side vacuum chuck 9 with a finished ophthalmic device 10 after the second side or surface 12 of lens blank 100 has been created e.g., by lathe-cutting. Device 10 may be further processed, e.g., adding haptics, to produce e.g., a completed lens or IOL.

FIGS. 7A and 7B illustrate a finished ophthalmic device where the finished devices are an intraocular lens body 11, and is a contact lens 12, respectively.

### DETAILED DESCRIPTION OF THE INVENTION

Traditional lathing methods used for lens manufacture use a motorized drive, termed the “spindle”, connected to a fixture, termed the “block” or “chuck”, which holds the lens blank. The process of holding the lens blank to the block will herein be referred to as “blocking”. The lens blank attached to the spindle via the block rotates rapidly about the spindle axis as diamond cutting tools shape the lens blank. The resulting first-side lens center and lens axis is collinear with the spindle axis. The incomplete lens blank is removed from the block and re-positioned on a separate block with the non-lathed surface of the lens blank exposed. The cutting process is repeated for the second-side to complete the lens shape. Ideally, the finished first-side optic and second-side optic are concentric with their respective centers aligned. This is not the case when the first-side optic surface is misaligned with the spindle axis during the lathing of the second-side optic geometry as is described above.

The invention is an alternative method of blocking that utilizes vacuum i.e., the application of subatmospheric pressure on one side of the lens blank to hold e.g., an IOL blank, to the spindle during forming (e.g., lathe cutting) and handling of the blank. This process will be generally referred to herein as a “vacuum chuck,” or “chuck”. Cutting of the ophthalmic device generally requires two vacuum chucks, one for the initial blank, and one for the half-finished blank to complete the second side cut. The first side cut of the ophthalmic device is performed by using the outside geometry of the blank to center the blank relative to the spindle axis. The blank is held to the chuck with the use of vacuum. In practice this generally means that a subatmospheric pressure zone or region is generated and maintained on one side of a lens or blank with atmospheric pressure on the other side of the blank or lens holding the blank or lens in a designated manner or position. Cutting of the second side of the ophthalmic device uses the geometry of the first cut side to hold the blank centered on the vacuum chuck. The half-finished blank is held to the chuck by means of vacuum while being lathe cut to complete the manufacturing process.

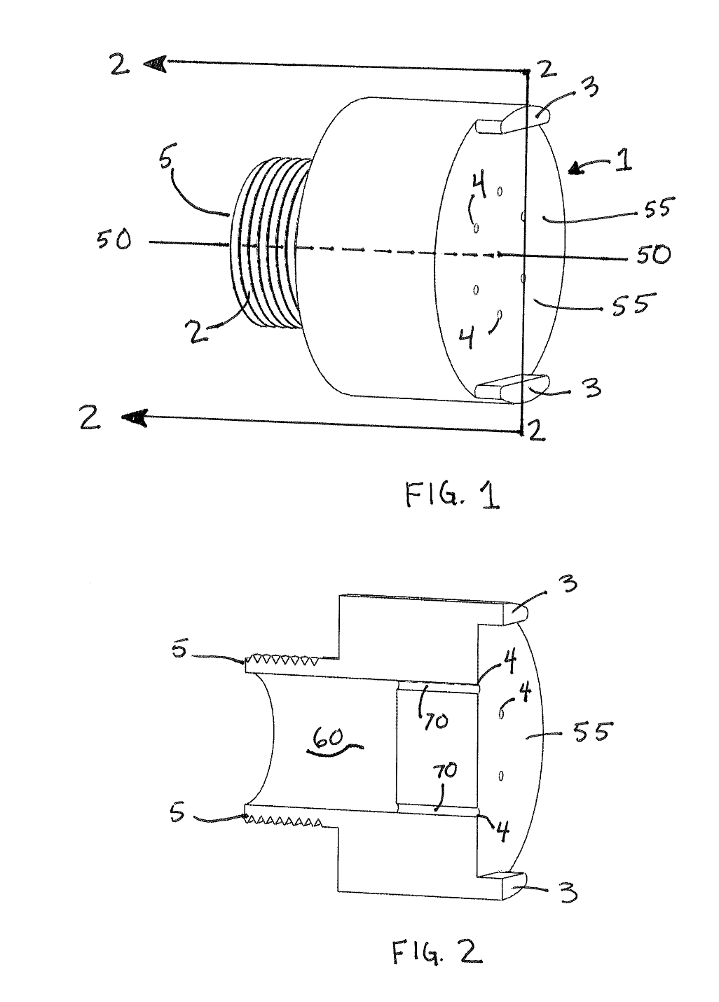

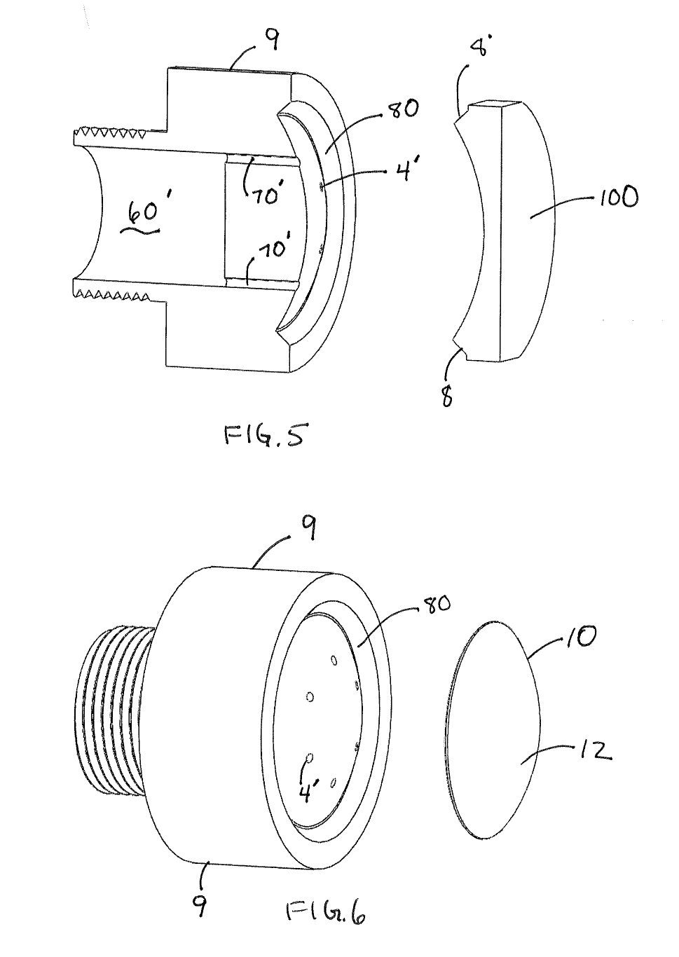

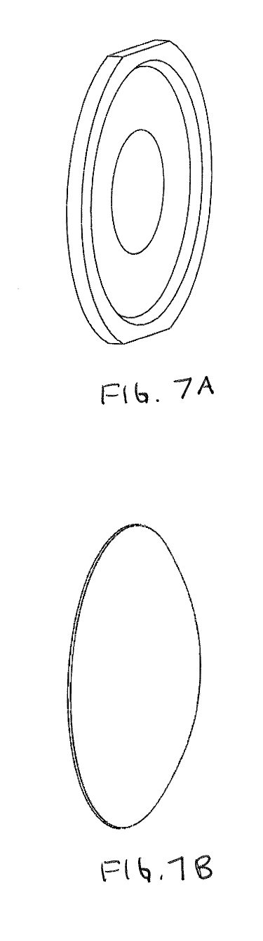

Reference now is made to the FIGS. 1-7, briefly described above and the detailed disclosure which follows.

In one aspect, the present invention is an improved method of deploying or, in essence, holding or supporting or transporting an optical or ophthalmic device blank onto a blocking fixture for lathe-cutting of optical lens blank surfaces. Specifically, this invention is an improved method for lathe-cutting of optical lens blanks which become the optical portion or lens body of ophthalmic devices. Instead of the traditional blocking methods for blanks that use a collet system or wax-blocking system, this invention uses vacuum (i.e., subatmospheric pressure) and atmospheric pressure to hold the blank in place while it is undergoing machining modification; treatment or is being transported while in manufacture. Two vacuum chucks are generally needed for the production of a finished optical lens body with geometry on both anterior and posterior surfaces. A single vacuum chuck is needed if only a plano-convex or plano-concave optical lens is to be produced.

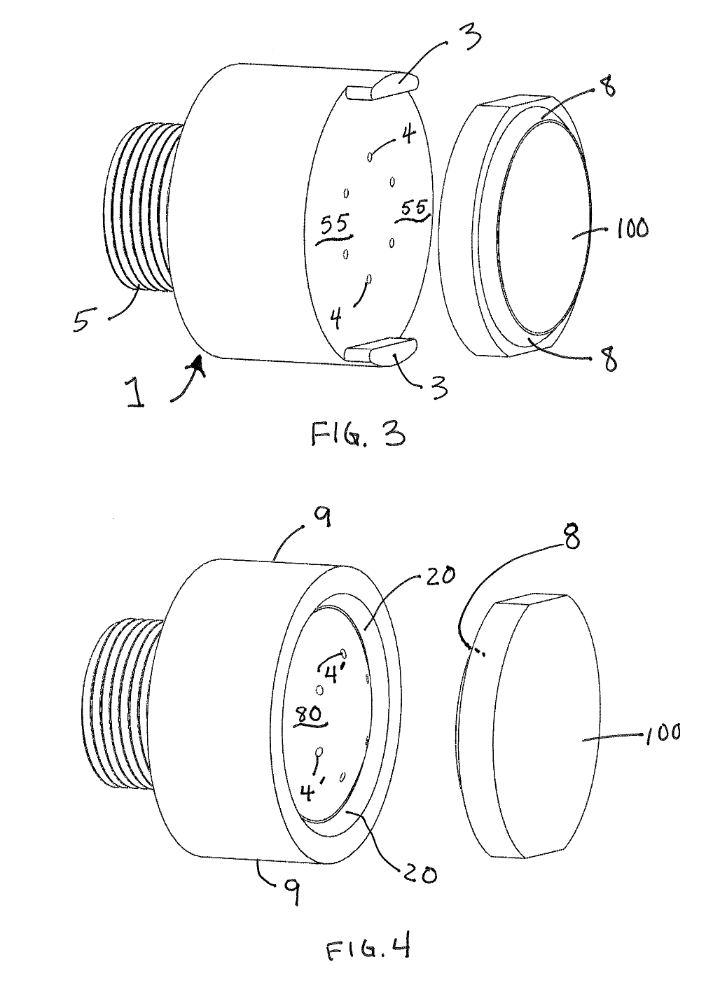

The vacuum chuck 1 used for cutting the first side of the blank 100 (see, FIG. 3) comprises a surface or face 55, generally disposed perpendicular to the axis of revolution 50 of the chuck 1. Lens blank 100 abuts against and is retained by atmospheric pressure operating against a vacuum drawn through vacuum ports 4. Additional surface geometry, i.e., guides 3, is used to interface with the lens blank to prevent its rotation relative to chuck 1 during cutting and to promote concentricity of the blank to the axis of the spindle rotation 50. FIG. 1 depicts two identical protrusions 3 that extend from the chuck face 55 which are rotationally symmetric along the spindle axis 50. Depending on the nature of the material and the cutting parameters to be employed, vacuum pressure is generally a sufficiently strong hold or “hard” to the material blank 100 to the surface of the chuck 55.

Adjustment of the strength or “hardness” of the vacuum draw may be needed depending upon the extent of blank surface modification to be undertaken. The clocking geometry or structure aforementioned need not protrude from the vacuum chuck, but may also be negatively defined by the chuck face 55, i.e., chuck face 55 may have receptive or concave surface features which assist in holding blank 100 to chuck face 55. Therefore, the invention includes a device that holds onto the lens material blank via creation of a vacuum pressure and may or may not have additional projecting or indenting clocking geometry or surface structure that protrudes away from or recesses into the chuck face 55 and that may or may not be rotationally symmetric along the spindle axis 50.

Attachment of the invention to the machine spindle of a lathe is through the use of a threaded vacuum chuck body. Other means of attachment of the invention to the machine spindle includes, but is not limited to collets, Morse tapers, Jacob's tapers, adjustable chucks, and set screws.

As the invention holds onto the lens material blank mainly via vacuum force, lens material blanks 100 and the vacuum chuck face 55 are required to have a relatively smooth surface to ensure an adequate seal is achieved. Positive or negative keying geometry to prevent lens rotation relative to chuck face 55 and to promote lens concentricity can be contained on the lens blanks. Structure can be recessed into or extending out from the surface of the material blank to interface with face of the vacuum chuck, which itself may have positive or negative cooperating features.

After the lens blank first side has been cut, pressed, drilled, molded or otherwise formed, the partially completed lens blank is removed from the first chuck by releasing the vacuum. The completed side of the lens blank then is mated with or positioned against a second chuck face and the remaining or second lens blank surface is formed, e.g., by cutting, molding, drilling, etc., as with the first lens blank surface. Upon completion of processing of the second lens blank surface, the vacuum is again interrupted and the now nearly completed lens blank 10 is sent to final processing or assembly (e.g., to attach or mill haptics).

Cutting of the second side of the optical lens blank is performed with the use of a second-side vacuum chuck. The geometry of the first-side-cut material blank is used to center the blank relative to the second-side vacuum chuck. The chuck face is an exact negative of the first-side-cut material blank. Ideally, the second-side vacuum chuck geometry would be cut on the same machine that would be used to create the optical lens. This maximizes the accuracy in the positioning of the invention relative to the spindle axis as well as ensures a precise fit between the first-side-cut blank and the vacuum chuck.

The vacuum chuck body can be made from many different metals including, but not limited to, various grades of brass, aluminum, and stainless steel. The vacuum chuck face may be constructed separately from the body and comprise a material other than that of the chuck body. The vacuum chuck face may be constructed from many different materials including, but not limited to, metals such as brass, aluminum, and stainless steel and plastics such as acrylic, and PMMA. In optical lens applications where heat buildup is a concern, a material with a high thermal conductivity is recommended to aid in heat dissipation. Durable and easily machineable metals such as naval brass or air force grade aluminums are ideal in this situation.

What is claimed is as follows:

1. A method of forming an optical device lens blank having two sides into an optical device lens body comprising the steps of:
a. providing and an optical device lens blank;
b. providing a blocking fixture for a lathe cutting apparatus, the fixture having a body which defines a surface configured to cooperate with the lens blank, the body further having a vacuum header and defining a plurality of ports in the surface, the body further defining a series of conduits providing vacuum communication between the ports and the header;
c. applying the lens blank to the surface while generating subatmospheric pressure in the header which, via the conduits and ports, holds the lens blank to the surface on one side; and
d. lathe cutting the remaining side of the blank to at least partially create the lens body surface configuration while holding the lens body to the surface with negative pressure.

2. A blocking method according to claim 1 wherein the blocking fixture is a vacuum chuck and the vacuum chuck attaches to a machine spindle of a lathe by means including, but not limited to:
a. threads;
b. collets;
c. Morse tapers;
d. Jacob's tapers;
e. adjustable chucks; and
f. set screws.

3. A blocking method according to claim 2 where the vacuum chuck body is constructed from materials including, but not limited to:
a. stainless steel;
b. brass; and
c. aluminum.

4. A blocking method according to claim 3 where the fixture is an assembly made up of at least two parts, including the vacuum chuck body and the vacuum chuck face.

5. A blocking method according to claim 4 where the vacuum chuck face attaches to the vacuum chuck body via methods including, but not limited to:
a. threads;
b. collets;
c. Morse tapers;
d. Jacob's tapers;
e. adjustable chucks; and
f. set screws.

6. A blocking method according to claim 5 where the vacuum chuck face is made of a different material from the vacuum chuck body including, but not limited to:
a. stainless steel;
b. brass;
c. aluminum;
d. acrylic; and
e. PMMA

7. A blocking method according to claim 3 where blocking geometry is used to interface with the optical lens blanks to:
a. promote concentricity of the optical lens blank to the vacuum chuck and spindle axes; and
b. eliminate rotation of the optical lens blank relative to the vacuum chuck face.

8. A blocking method according to claim 3 where the method is a single vacuum chuck for the use of cutting a plano-convex or plano-concave optical lens.

9. A blocking method according to claim 3 where the method is a set of two vacuum chucks for the use of cutting either convex-convex, convex-concave, concave-concave, or concave-convex optical lenses consisting of:
a. A first-side vacuum chuck for cutting of the first surface of the optical lens; and
b. a second-side vacuum chuck that interfaces with the first-side-cut of the optical lens for cutting the second surface of the optical lens.

10. A blocking device according to claim 3 where the optical lens is a contact lens.

11. A blocking device according to claim 3 where the optical lens is an intraocular lens (IOL).
